(19) United States
(12) Patent Application Publication
(10) Pub. No.: US 2020/0134954 A1
(43) Pub. Date: Apr. 30, 2020

(54) ACCESS CONTROL METHODS AND APPARATUSES, SYSTEMS, ELECTRONIC DEVICES, PROGRAMS, AND MEDIUM

(71) Applicant: SHENZHEN SENSETIME TECHNOLOGY CO., LTD., Shenzhen (CN)

(72) Inventors: Chengming YI, SHENZHEN (CN); Chendi YU, SHENZHEN (CN); Wenzhi LIU, SHENZHEN (CN)

(73) Assignee: SHENZHEN SENSETIME TECHNOLOGY CO., LTD., Shenzhen (CN)

(21) Appl. No.: 16/720,141

(22) Filed: Dec. 19, 2019

Related U.S. Application Data
(63) Continuation of application No. PCT/CN2018/096241, filed on Jul. 19, 2018.

(30) Foreign Application Priority Data
Jul. 20, 2017 (CN) 201710594921.9

(51) Int. Cl. G07C 9/25; G07C 9/23; G07C 9/10; G06K 9/00

(52) U.S. Cl. CPC G07C 9/257; G06K 9/00255; G07C 9/10; G07C 9/23

(57) ABSTRACT

An access control includes: performing, by a camera device, video data collection to obtain video data; performing, by the camera device, face image detection on the video data; in response to a face image being detected, performing, by the camera device, authentication on the face image; and outputting, by the camera device according to whether extracted feature data passes the authentication, a corresponding access control signal, so that an access control linkage apparatus opens or closes a door. Based on the embodiments of the present disclosure, the convenience and safety when a user passes through an access control are improved, the detection time is short, the detection efficiency is high, and the security of user data is improved.

### CROSS-REFERENCE TO RELATED APPLICATIONS

The present application is a continuation of International Application No. PCT/CN2018/096241 filed on Jul. 19, 2018, which claims priority to Chinese Patent Application No. 201710594921.9 filed on Jul. 20, 2017. The disclosures of these applications are hereby incorporated by reference in their entirety.

### BACKGROUND

A conventional access control system mainly includes a password access control system and a card-swiping access control system.

The password access control system refers to that a password input device is provided at the entrance of an access control, a user inputs a password on the password input device when passing through the access control system, and when the password input by the user is correct, the user can pass through the access control.

The card-swiping access control system refers to that a non-contact integrated circuit (IC) card is used, and an access control card reader is placed at the entrance of an access control; when a user enters, the user needs to touch or approach the card reader gently, just like swiping a bus card, to perform a card swiping operation, and thus, the card reader can read card information of the IC card. When the card information is correct, the user can pass the access control.

### SUMMARY

The present disclosure relates to computer vision technologies, and in particular to access control methods and apparatuses, systems, electronic devices, programs, and medium.

Embodiments of the present disclosure provide technical solutions of an access control system.

An access control method provided according to one aspect of the embodiments of the present disclosure includes: performing, by a camera device, video data collection to obtain video data; performing, by the camera device, face image detection on the video data; in response to a face image being detected, performing, by the camera device, feature data extraction on the face image, and performing authentication on extracted feature data based on a feature database built in the camera device; and outputting, by the camera device according to a result of the authentication, a corresponding access control signal, the access control signal being used for opening or closing a door by an access control linkage apparatus.

An access control apparatus provided according to another aspect of the embodiments of the present disclosure includes: a memory storing processor-executable instructions; and a processor arranged to execute the stored processor-executable instructions to perform steps of: performing video data collection to obtain video data; performing face image detection on the video data, and in response to a face image being detected, performing authentication on the face image; and outputting, according to a result of the authentication output by the first face detection module, a corresponding access control signal, the access control signal being used for opening or closing a door by an access control linkage apparatus.

An access control apparatus provided according to another aspect of the embodiments of the present disclosure includes: a first collection module, configured to perform video data collection to obtain video data; a first face detection module, configured to perform face image detection on the video data, and in response to a face image being detected, perform authentication on the face image; and a control module, configured to output, according to a result of the authentication, a corresponding access control signal, the access control signal being used for opening or closing a door by an access control linkage apparatus.

An access control system provided according to still another aspect of the embodiments of the present disclosure includes: a terminal device comprising a memory storing processor-executable instructions; and a processor configured to execute the stored processor-executable instructions to perform steps of: collecting an image; performing face detection on the collected image; and in response to a face being detected in the collected image, performing feature data extraction on the face in the image to obtain face feature data of a user permitted to pass, and sending the face feature data to a camera device; and the camera device, configured to: receive the face feature data of the user permitted to pass sent by the terminal device, and store the face feature data of the user permitted to pass in a feature database built in the camera device; perform video data collection to obtain video data; perform face image detection on the video data; in response to a face image being detected, perform authentication on the face image; and output, according to a result of the authentication, a corresponding access control signal, the access control signal being used for opening or closing a door by an access control linkage apparatus.

An electronic device provided according to yet another aspect of the embodiments of the present disclosure includes: the access control apparatus according to any one of the embodiments of the present disclosure, or the access control system according to any one of the embodiments of the present disclosure.

An electronic device provided according to yet another aspect of the embodiments of the present disclosure includes: a processor and the access control apparatus according to any one of the embodiments of the present disclosure; where when the processor runs the access control apparatus, modules in the access control apparatus according to any one of the embodiments of the present disclosure are run.

An electronic device provided according to yet another aspect of the embodiments of the present disclosure includes: a processor and the access control system according to any one of the embodiments of the present disclosure; where when the processor runs the access control system, modules in the access control system according to any one of the embodiments of the present disclosure are run.

An electronic device provided according to yet another aspect of the embodiments of the present disclosure includes: a memory, which stores executable instructions; and one or more processors, which communicate with the memory to execute the executable instructions so as to complete operations of the operations in the access control method according to any one of the embodiments of the present disclosure.

A computer program provided according to yet another aspect of the embodiments of the present disclosure includes a computer-readable code, where when the computer-readable code is run on a device, a processor in the device executes instructions for implementing operations of the access control method according to any one of the embodiments of the present disclosure.

A computer-readable medium provided according to yet another aspect of the embodiments of the present disclosure is configured to store computer-readable instructions, where when the instructions are executed, operations of the operations in the access control method according to any one of the embodiments of the present disclosure are implemented.

The following further describes in detail the technical solutions of the present disclosure with reference to the accompanying drawings and embodiments.

### BRIEF DESCRIPTION OF DRAWINGS

The accompanying drawings constituting a part of the specification describe the embodiments of the present disclosure and are intended to explain the principles of the present disclosure together with the descriptions.

According to the following detailed descriptions, the present disclosure may be understood more clearly with reference to the accompanying drawings.

FIG. 1 is a flowchart of an embodiment of an access control method according to the present disclosure.

FIG. 2 is a flowchart of another embodiment of an access control method according to the present disclosure.

FIG. 3 is a flowchart of still another embodiment of an access control method according to the present disclosure.

FIG. 4 is a schematic structural diagram of an embodiment of an access control apparatus according to the present disclosure.

FIG. 5 is a schematic structural diagram of another embodiment of an access control apparatus according to the present disclosure.

FIG. 6 is a schematic structural diagram of an embodiment of an access control system according to the present disclosure.

FIG. 7 is a schematic structural diagram of another embodiment of an access control system according to the present disclosure.

FIG. 8 is a schematic diagram of an embodiment of an access control system according to the present disclosure.

FIG. 9 is a schematic structural diagram of an embodiment of an electronic device according to the present disclosure.

### DETAILED DESCRIPTION

Various exemplary embodiments of the present disclosure are now described in detail with reference to the accompanying drawings. It should be noted that, unless otherwise stated specifically, relative arrangement of the components, the numerical expressions, and the values set forth in the embodiments are not intended to limit the scope of the present disclosure.

In addition, it should be understood that, for ease of description, the size of each part shown in the accompanying drawings is not drawn in actual proportion.

The following descriptions of at least one exemplary embodiment are merely illustrative actually, and are not intended to limit the present disclosure and the disclosure s or uses thereof.

Technologies, methods and devices known to a person of ordinary skill in the related art may not be discussed in detail, but such technologies, methods and devices should be considered as a part of the specification in appropriate situations.

A person skilled in the art may understand that the terms such as “first” and “second” in the embodiments of the present disclosure are only used to distinguish different operations, devices or modules, etc., and do not represent any specific technical meaning or an inevitable logical sequence therebetween.

It should be noted that similar reference numerals and letters in the following accompanying drawings represent similar items. Therefore, once an item is defined in an accompanying drawing, the item does not need to be further discussed in the subsequent accompanying drawings.

The embodiments of the present disclosure may be applied to electronic devices such as terminal devices, computer systems, and servers, which may operate with numerous other general-purpose or special-purpose computing system environments or configurations. Examples of well-known computing systems, environments, and/or configurations suitable for use together with the computer systems/servers include, but are not limited to, personal computer systems, server computer systems, thin clients, thick clients, handheld or laptop devices, microprocessor-based systems, set top boxes, programmable consumer electronics, network personal computers, small computer systems, large computer systems, distributed cloud computing environments that include any one of the foregoing systems.

The electronic devices such as terminal devices, computer systems, and servers may be described in the general context of computer system executable instructions (for example, program modules) executed by the computer system. Generally, the program modules may include routines, programs, target programs, components, logics, data structures, and the like for performing specific tasks or implementing specific abstract data types. Generally, the program modules may include routines, programs, target programs, components, logics, data structures, and the like for performing specific tasks or implementing specific abstract data types. In the distributed computing environments, the program modules may be located in local or remote computing system storage media including storage devices.

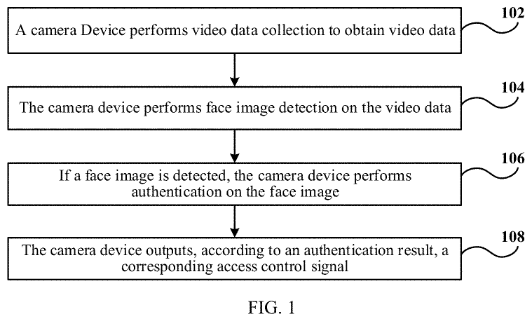

FIG. 1 is a flowchart of an embodiment of an access control method according to the present disclosure. As shown in FIG. 1, the access control method according to this embodiment includes:

102: A camera device performs video data collection to obtain video data.

In one optional embodiment, the operation 102 may be executed by a processor by invoking a corresponding instruction stored in a memory, and may also be executed by a first collection module 402 run by the processor.

104: The camera device performs face image detection on the video data.

In response to a face image being detected, operation 106 is executed. If no face image is detected, the subsequent data process of this embodiment is not executed.

In one of the optional embodiment, in the operation 104, the camera device may select an image from the video data, and performs face detection on the selected image based on a deep learning network. When a face is detected from the selected image, the face image is detected.

When the camera device selects an image from the video data, one or more image frames of higher quality may be selected from the video data for face detection, where the quality of the image is considered, for example, in terms of indexes, such as image sharpness, the front side of the face, and face size, and the image that has higher image sharpness, is more front-facing, and has larger face size has better quality.

106: The camera device performs authentication on the face image.

In one optional embodiment, the operations 104-106 may be executed by the processor by invoking corresponding instructions stored in the memory, and may also be executed by a first face detection module 404 run by the processor.

108: The camera device outputs, according to a result of the authentication, a corresponding access control signal, the access control signal being used for opening or closing a door by an access control linkage apparatus.

In one optional embodiment, the operation 108 may be performed by the processor invoking a corresponding instruction stored in the memory, and may also be executed by a control module 406 run by the processor.

Based on the access control method provided according to the foregoing embodiments of the present disclosure, video data collection is performed by means of a camera device, and face image detection is performed on the collected video data; when a face image is detected, authentication is performed on the face image, and a door is controlled to be opened or closed according to a result of the authentication. Based on the embodiments of the present disclosure, a user does not need to enter a password or swipe a card when passing through an access control, thereby improving the convenience and safety; moreover, access control procedures, such as the video data collection, and the face image detection and authentication, are performed based on the camera device itself, and do not need to be processed by a background server or a third-party server, so the detection time is short, the detection efficiency is high, and no data transmission with the background server or the third-party server is needed, thereby reducing the amount of data transmitted by a network and improving the security of user data. Furthermore, data leakage and privacy problems caused to users by using the back-end server or the third-party server can be effectively reduced.

In one optional example of the embodiments of the access control method of the present disclosure, operation 106 may be implemented as follows:

The camera device performs feature data extraction on the face image, and performs authentication on the extracted feature data based on a feature database built in the camera device. The feature database stores feature data which can and/or cannot pass the authentication.

Exemplarily, the feature data may be stored in the feature database in the form of binary data or text data. In this case, the feature data occupies less storage space, and the feature database built in the camera device may store a great amount of user feature data to meet access control requirements. The feature data is less easily leaked when stored in the feature database in the form of binary data, thereby contributing to the improvement of the security of user information.

If the extracted feature data passes the authentication, in operation 108, the camera device outputs a door opening control signal, and the door opening control signal is used for performing a door opening operation by the access control linkage apparatus. Based on one or more embodiments, the user passing the authentication may pass through the electronic door in the access control linkage apparatus in time.

Based on the access control method provided according to the foregoing embodiments of the present disclosure, video data collection is performed by means of a camera device, and face image detection is performed on the collected video data; when a face image is detected, feature data extraction is performed on the face image, authentication is performed on the extracted feature data based on a built-in feature database, and a door is controlled to be opened or closed according to a result of the authentication. Based on the embodiments of the present disclosure, a user does not need to enter a password or swipe a card when passing through an access control, thereby improving the convenience and safety; moreover, access control procedures, such as the video data collection, the face image detection, and the feature data extraction authentication, are performed based on the camera device itself, and do not need to be processed by a background server or a third-party server, so the detection time is short, the detection efficiency is high, and no data transmission with the background server or the third-party server is needed, thereby reducing the amount of data transmitted by a network and improving the security of user data. Furthermore, data leakage and privacy problems caused to users by using the back-end server or the third-party server can be effectively reduced.

In addition, in an further optional embodiment, after the camera device outputs the door opening control signal, in response to no face image being detected within a preset time period, the camera device outputs a door closing control signal. The door closing control signal is used for performing a door closing operation by the access control linkage apparatus. Based on the embodiment, after the user permitted to pass passes through the access control, the electronic door in the access control linkage apparatus is changed from an open state to a closed state in time, thereby preventing illegal users from entering and improving the safety.

In another example of the access control method of the present disclosure, the feature database may include a whitelist. The whitelist is used for storing first user information. The first user information includes face feature data of a user permitted to pass, and furthermore, may also selectively include user identification information of the user permitted to pass, such as the name, age, gender, head photo, specific address and other related user information of the user.

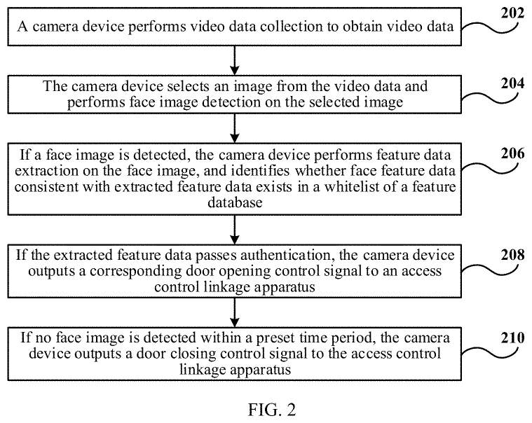

FIG. 2 is a flowchart of another embodiment of an access control method according to the present disclosure. As shown in FIG. 2, the access control method according to this embodiment includes:

202: A camera device performs video data collection to obtain video data.

In one optional embodiment, the operation 202 may be executed by a processor by invoking a corresponding instruction stored in a memory, and may also be executed by a first collection module 402 run by the processor.

204: The camera device selects an image from the video data, and performs face image detection on the selected image.

In the embodiments of the present disclosure, the face image detection may be performed by a convolutional neural network (CNN) of a deep neural technology based on a deep learning network.

In response to a face image being detected in the selected image, operation 206 is executed. If no face image is detected from the selected image, the subsequent data process of this embodiment is not executed.

206: The camera device performs feature data extraction on the face image, and identifies whether face feature data consistent with the extracted feature data exists in a whitelist of a feature database.

The feature database may include a whitelist, and the whitelist is used for storing first user information. The first user information includes face feature data of a user permitted to pass, and furthermore, may also selectively include user identification information of the user permitted to pass, such as the name, age, gender, head photo, specific address and other related user information of the user.

If face feature data consistent with the extracted feature data exists in the whitelist, and the extracted feature data passes the authentication, operation 208 is executed. If no face feature data consistent with the extracted feature data exists in the whitelist, and the extracted feature data does not pass the authentication, and the subsequent data process of this embodiment is not executed; or selectively, the camera device outputs prompt information indicating that the current user is a stranger.

In one of the optional embodiment, the identifying whether face feature data consistent with the extracted feature data exists in the whitelist of the feature database may be implemented as follows:

obtaining the similarity between the extracted feature data and the face feature data in the whitelist;

comparing whether face feature data having similarity of greater than a preset threshold to the extracted feature data exists in the whitelist; and

if the face feature data having similarity of greater than the preset threshold to the extracted feature data exists in the whitelist, determining that the face feature data consistent with the extracted feature data exists in the whitelist; if no face feature data having similarity of greater than the preset threshold to the extracted feature data exists in the whitelist, determining that no face feature data consistent with the extracted feature data exists in the whitelist.

In some embodiments of the present disclosure, the features used for face recognition may be visual features, pixel statistic features, face image transform coefficient features, face image algebra features, etc., and the feature data extraction performed on the face image is directed to some features of the face. The face feature extraction is also referred to as face representation. In the embodiments of the present disclosure, the feature data of the face image may be extracted by a convolutional neural network (CNN) of a deep neural technology based on a deep learning network. Since the feature data of different faces is different, but the feature data of the same face is similar, the feature data of the extracted face image may be compared with the face feature data in the feature database built in the camera device to determine the similarity therebetween. If the feature data in the feature database that has the highest similarity to the feature data of the extracted face image and the similarity is greater than a preset threshold, the face feature data is considered to be the face feature data consistent with the feature data of the extracted face image.

In some embodiments of the present disclosure, the extracted feature data and the face feature data in the feature database may be represented as a feature vector, and the Euclidean distance, cosine distance, or other distances between the extracted feature data and the face feature data in the feature database may be compared to obtain the similarity between the two, thereby identifying whether the two are consistent, i.e., whether the two are the feature data of the same face. The smaller the Euclidean distance, cosine distance, or other distances between the extracted feature data and the face feature data in the feature database, the higher the similarity. The greater the Euclidean distance, cosine distance, or other distances between the extracted feature data and the face feature data in the feature database, the lower the similarity.

In some embodiments of the present disclosure, when the similarity between the extracted feature data and the face feature data in the whitelist is obtained, the similarity between the face feature data in the whitelist and the extracted feature data may be obtained one by one, and whether the similarity is greater than the preset threshold is determined through comparison, i.e., the aforementioned operation of identifying whether the face feature data consistent with the extracted feature data exists in the whitelist of the feature database is executed respectively for each piece of face feature data in the whitelist. When there is one piece of face feature data having similarity of greater than the preset threshold in the whitelist, it is confirmed that the face feature data consistent with the extracted feature data exists in the white list, and the operation of identifying whether the face feature data consistent with the extracted feature data exists in the whitelist of the feature database is no longer performed for the subsequent face feature data in the whitelist.

In addition, when the similarity between the extracted feature data and the face feature data in the whitelist is obtained, the similarity between a part of face feature data in the whitelist and the extracted feature data may also be obtained at the same time, and it is compared whether each similarity is greater than the preset threshold. When there is the face feature data having similarity of greater than the preset threshold in the part of the face feature data, it is confirmed that the face feature data consistent with the extracted feature data exists in the whitelist, and the operation of identifying whether the face feature data consistent with the extracted feature data exists in the whitelist of the feature database is no longer continued for the remaining part of the face feature data in the whitelist. If no face feature data having similarity of greater than the preset threshold exists in the part of the facial feature data, the next part of the face feature data in the whitelist is selected so as to perform the operation of identifying whether the face feature data consistent with the extracted feature data exists in the whitelist of the feature database thereon, until it is found that no face feature data corresponding to the extracted feature data exists in the face feature data having similarity of greater than the preset threshold or in the entire whitelist.

Alternatively, when the similarity between the extracted feature data and the face feature data in the whitelist is obtained, the similarity between all the face feature data in the whitelist and the extracted feature data may also be obtained at the same time, and it is compared whether each similarity is greater than the preset threshold. When there is one piece of face feature data having similarity of greater than the preset threshold in the whitelist, it is confirmed that the face feature data consistent with the extracted feature data exists in the whitelist, or otherwise, it is confirmed that no face feature data consistent with the extracted feature data exists in the entire whitelist.

In one optional embodiment, the operations 204-206 may be executed by the processor by invoking corresponding instructions stored in the memory, and may also be executed by a first face detection module 404 run by the processor.

208: If the extracted feature data passes through the authentication, the camera device outputs a corresponding door opening control signal to the access control linkage apparatus, the door opening control signal being used for performing a door opening operation by the door opening linkage apparatus.

In one optional embodiment, the operation 208 may be performed by the processor invoking a corresponding instruction stored in the memory, and may also be executed by a control module 406 run by the processor.

In addition, referring to FIG. 2 again, in still another embodiment of the access control method according to the present disclosure, after the camera device outputs the door opening control signal, the method may further include:

210: In response to no face image being detected within a preset time period, the camera device outputs a door closing control signal to the access control linkage apparatus, the door closing control signal being used for performing a door closing operation by the access control linkage apparatus.

In one embodiment, after the user permitted to pass passes through the access control, the electronic door in the access control linkage apparatus is changed from an open state to a closed state in time, thereby preventing illegal users from entering and improving the safety of the access control system.

Then, the subsequent procedures of this embodiment are not executed.

In one optional embodiment, the operation 210 may be performed by the processor invoking a corresponding instruction stored in the memory, and may also be executed by a control module 406 run by the processor.

In addition, in one optional implementation scheme of the foregoing embodiments of the present disclosure, the feature database further includes: a blacklist. The blacklist is used for storing second user information. The second user information includes face feature data of a user forbidden to pass, and furthermore, may also selectively include user identification information of the user forbidden to pass, such as the name, age, gender, head photo, specific address and other related user information of the user.

Accordingly, in the embodiments, when the camera device performs authentication on the extracted feature data based on the feature database built in the camera device, the method may include:

identifying whether face feature data consistent with the extracted feature data exists in the blacklist; and

if the face feature data consistent with the extracted feature data exists in the blacklist, the extracted feature data does not pass the authentication.

If the electronic door in the access control linkage apparatus is currently in the closed state, the camera device does not perform any operation on the result of the authentication. If the electronic door in the access control linkage apparatus is currently in the open state, the camera device sends a door closing control signal to the access control linkage apparatus. The door closing control signal is used for performing a door closing operation on the access control linkage apparatus, thereby improving the safety of the access control system.

In one or more embodiments of the present disclosure, the access control linkage apparatus includes a relay and an electronic door, is a combination apparatus of the relay and the electronic door, and serves as a response apparatus for receiving the access control signal of the camera device. When the camera device sends a door opening control signal, the relay in the access control linkage apparatus controls the electronic door to be opened according to the door opening control signal to allow the user to pass through. On the contrary, when the camera device sends a door closing control signal, the relay in the access control linkage apparatus controls the electronic door to be closed according to the door closing control signal to prevent the user from passing through.

Further, in another optional implementation scheme of the foregoing embodiments of the present disclosure, if the face feature data consistent with the extracted feature data exists in the blacklist, the camera device may also control an alarm apparatus to give an alarm. For example, the alarm may be given by means of text, sound, light, electricity, and the like.

Further, in some embodiments based on the access control method of the present disclosure, after a face image being detected from the video data, living body detection may also performed on the video data by using a deep learning network. Only after the extracted feature data passes the authentication and also passes the living body detection, the camera device outputs a door opening control signal to control the door opening linkage apparatus to perform a door opening operation. If the extracted feature data does not pass the authentication and/or the living body detection, the camera device does not output the door opening control signal or outputs a door closing control signal to ensure that the electronic door in the access control linkage apparatus is in the closed state. In an optional example, authentication may be performed on extracted feature data first, or living body detection may be performed on the video data first, or the both operations may be performed simultaneously or in any time sequence.

In one of the optional examples, whether the living body detection passes is determined by detecting whether the user performs a valid specific action within the preset time period in the video data. If the user performs a valid specified action within the preset time period in the video data, the living body detection passes. If the user does not perform a valid specified action within the preset time period in the video data, the living body detection does not pass.

Based on the foregoing embodiments, living body detection is further performed on the face image in the video data to detect whether the face image is active. The camera device outputs the door opening control signal only after the extracted feature data passes the authentication and also passes the living body detection, so that a case where the access control system is opened by using a printed photo of the user in the whitelist is avoided, thereby avoiding potential safety hazards and further improving the safety of the access control system.

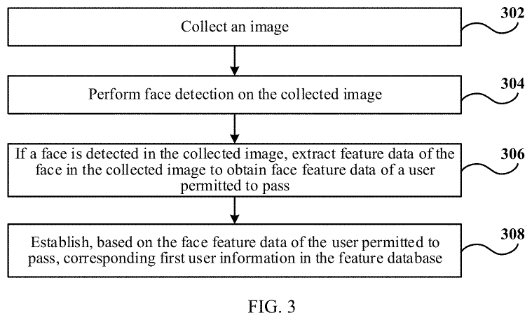

FIG. 3 is a data process flowchart of still another embodiment of an access control method according to the present disclosure. As shown in FIG. 3, in the foregoing embodiments of the access control method of the present disclosure, the method may further include:

302: An image is collected.

304: Face detection is performed on the collected image.

In response to a face being detected in the collected image, operation 306 is executed. Otherwise, the subsequent data process of this embodiment is not executed.

306. Feature data of the face in the collected image is extracted to obtain face feature data of a user permitted to pass.

308: Based on the face feature data of the user permitted to pass, corresponding first user information is established in a feature database.

The first user information includes the face feature data of the user permitted to pass, and furthermore, may also selectively include user identification information of the user permitted to pass, such as the name, age, gender, head photo, specific address and other related user information of the user.

In one optional implementation scheme, the operations 302-308 can be specifically implemented by means of a terminal device. The terminal device serves as a management client of the camera device in the embodiments of the present disclosure, and establishes a matching and communication connection (for example, a communication connection based on a mobile communication network, a mobile data network, and a local area network) with the camera device, thereby implementing the management of the camera device.

The flow of the embodiment shown in FIG. 3 may be performed before or after the flow of the embodiment shown in FIG. 1 or 2, or performed concurrently with any of the operations in the embodiment shown in FIG. 1 or 2.

In addition, after the corresponding first user information is established in the feature database, other face feature data of the user permitted to pass may be added to the feature database, that is, the first user information of other users permitted to pass may be established in the feature database through the operations 302-308 of the embodiment shown in FIG. 3. In addition, the terminal device may also delete the first user information of one or more users from the feature database after establishing the matching and communication connection relationship with the camera device.

Based on the foregoing embodiments, timely update of the face feature data in the feature database can be implemented, so as to effective manage the users permitted to pass.

In one optional example of the embodiment shown in FIG. 3, the operation 308 may include:

sending the first user information of the user permitted to pass to the camera device by means the communication device through a communication network (e.g., a mobile communication network, a mobile data network, a local area network, etc.); and

establishing, by the camera device, the first user information of the user permitted to pass in the whitelist of the feature database, the first user information including the user identification information and the face feature data of the user permitted to pass.

In addition, based on a further embodiment of the embodiment shown in FIG. 3, the method may include:

sending second user information of a user forbidden to pass to the camera device by means the communication device through a communication network (e.g., a mobile communication network, a mobile data network, a local area network, etc.), where the second user information includes face feature data of the user forbidden to pass, and furthermore, may also selectively include user identification information of the user forbidden to pass; and

storing, by the camera device, the second user information of the user forbidden to pass in the blacklist of the feature database.

In one optional implementation mode, the terminal device may transmit the first user information and/or the second user information in the form of text data or binary data, thereby reducing the amount of data transmission, saving network bandwidth, and improving data transmission efficiency and success rate.

Further, in yet still another embodiment of the access control method of the present disclosure, the method may further include:

recording, by the camera device, user passage information in a monitoring log, where the user passage information includes information of each user and the time when the user passes through the electronic door in the access control linkage apparatus or the time when other users fail to pass the authentication. The user information may include user identification information, and/or the face feature data of the user.

Based on the embodiments, the user passage information within the monitoring range of the camera device can be effectively recorded. In a further embodiment, the method further includes:

in response to reception of a query request, querying, by the camera device, the passage information satisfying a query condition in the query request from the monitoring log and outputting said information.

The query condition, for example, may be the name, age, gender, head photo, specific address, time period, and the like of the user. If the query condition is a head photo, the camera device first performs face detection and feature data extraction on the head photo, and then queries the access information satisfying the query condition from the monitoring log based on the extracted feature data.

Any access control method provided by the embodiments of the present disclosure may be executed by any appropriate device having data processing capability, including, but not limited to, a terminal device and a server, etc. Alternatively, any access control method provided in the embodiments of the present disclosure may be executed by a processor, for example, any access control method mentioned in the embodiments of the present disclosure is executed by the processor by invoking corresponding instructions stored in a memory. Details are not described below again.

A person of ordinary skill in the art may understand that: all or some operations for implementing the foregoing method embodiments are achieved by a program by instructing related hardware; the foregoing program may be stored in a computer-readable storage medium; when the program is executed, operations including the foregoing method embodiments are executed. Moreover, the foregoing storage medium includes various media capable of storing program codes, such as a ROM, a RAM, a magnetic disk, or an optical disk.

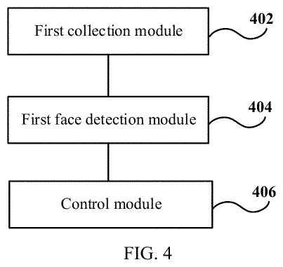

FIG. 4 is a schematic structural diagram of another embodiment of an access control apparatus according to the present disclosure. The access control apparatus of this embodiment is configured to implement the foregoing access control method embodiments of the present disclosure. As shown in FIG. 4, the access control apparatus of this embodiment includes: a first collection module 402, a first face detection module 404, and a control module 406.

The first collection module 402 is configured to perform video data collection to obtain video data.

The first face detection module 404 is configured to perform face image detection on the video data, and in response to a face image being detected, perform authentication on the face image.

In one optional implementation mode, the first face detection module 404 may be implemented based on a deep learning network, for example, implemented through a convolutional neural network (CNN) in deep learning.

The control module 406 is configured to output, according to a result of the authentication output by the first face detection module 404, a corresponding access control signal, the access control signal being used for opening or closing a door by an access control linkage apparatus.

Based on the access control apparatus provided according to the foregoing embodiments of the present disclosure, video data collection is performed by means of a camera device, and face image detection is performed on the collected video data; when a face image is detected, authentication is performed on the face image, and a door is controlled to be opened or closed according to a result of the authentication. Based on the embodiments of the present disclosure, a user does not need to enter a password or swipe a card when passing through an access control, thereby improving the convenience and safety; moreover, access control procedures, such as the video data collection, and the face image detection and authentication, are performed based on the camera device itself, and do not need to be processed by a background server or a third-party server, so the detection time is short, the detection efficiency is high, and no data transmission with the background server or the third-party server is needed, thereby reducing the amount of data transmitted by a network and improving the security of user data. Furthermore, data leakage and privacy problems caused to users by using the back-end server or the third-party server can be effectively reduced.

In one optional example of the embodiments of the access control apparatus according to the present disclosure, the first collection module 402 is configured to selects an image from the video data to send to the first face detection module 404. The first face detection module 404 is specifically configured to: perform face detection on the selected image based on a deep learning network; and in response to a face being detected in the selected image, perform feature data extraction on the face image based on the deep learning network, and perform authentication on the extracted feature data based on a feature database. Exemplarily, the first face detection module 404 may be implemented through a convolutional neural network based on a deep learning technology.

Based on the access control apparatus provided according to the foregoing embodiments of the present disclosure, video data collection is performed by means of a camera device, and face image detection is performed on the collected video data; when a face image is detected, feature data extraction is performed on the face image, authentication is performed on the extracted feature data based on a built-in feature database, and a door is controlled to be opened or closed according to a result of the authentication. Based on the embodiments of the present disclosure, a user does not need to enter a password or swipe a card when passing through an access control, thereby improving the convenience and safety; moreover, access control procedures, such as the video data collection, the face image detection, and the feature data extraction authentication, are performed based on the camera device itself, and do not need to be processed by a background server or a third-party server, so the detection time is short, the detection efficiency is high, and no data transmission with the background server or the third-party server is needed, thereby reducing the amount of data transmitted by a network and improving the security of user data. Furthermore, data leakage and privacy problems caused to users by using the back-end server or the third-party server can be effectively reduced.

In another optional example of the embodiments of the access control apparatus according to the present disclosure, the control module 406 specifically outputs a door opening control signal when the extracted feature data passes the authentication. The door opening control signal is used for performing a door opening operation by the access control linkage apparatus.

In addition, According to one or more embodiments of the present disclosure, the control module 406 is further configured to output a door closing control signal after outputting the door opening control signal, in response to no face image being detected within a preset time period. The door closing control signal is used for performing a door closing operation by the access control linkage apparatus.

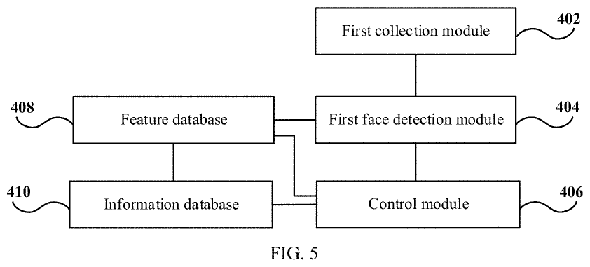

FIG. 5 is a schematic structural diagram of another embodiment of an access control apparatus according to the present disclosure. As shown in FIG. 5, compared with the access control apparatus according to the foregoing embodiments of the present disclosure, the access control apparatus of this embodiment further includes:

a feature database 408, which includes a whitelist. The whitelist is used for storing first user information. The first user information includes face feature data of a user permitted to pass, and furthermore, may also selectively include user identification information of the user permitted to pass, such as the name, age, gender, head photo, specific address and other related user information of the user.

Accordingly, in this embodiment, when performing authentication on the extracted feature data based on the feature database, the first face detection module 404 may be configured to: identify whether face feature data consistent with the extracted feature data exists in the whitelist; and if the face feature data consistent with the extracted feature data exists in the whitelist, the extracted feature data passes the authentication; if no face feature data consistent with the extracted feature data exists in the whitelist, the extracted feature data does not pass the authentication.

According to one or more embodiments of the present disclosure, in another optional example, the control module 406 may further be configured to output prompt information indicating that the current user is a stranger when no face feature data consistent with the extracted feature data exists in the whitelist.

In addition, in still another embodiment of the access control apparatus of the present disclosure, the feature database 408 may also include a blacklist. The blacklist is used for storing second user information. The second user information includes: face feature data of a user forbidden to pass, and furthermore, may also selectively include user identification information of the user forbidden to pass, such as the name, age, gender, head photo, specific address and other related user information of the user.

Accordingly, in this embodiment, when performing authentication on the extracted feature data based on the feature database, the first face detection module 404 may be configured to: identify whether face feature data consistent with the extracted feature data exists in the blacklist; and if the face feature data consistent with the extracted feature data exists in the blacklist, the extracted feature data passes the authentication; if no face feature data consistent with the extracted feature data exists in the blacklist, the extracted feature data does not pass the authentication.

In still another optional example of the embodiments of the access control apparatus according to the present disclosure, when identifying whether the face feature data consistent with the extracted feature data exists in the whitelist, the first face detection module 404 may be configured to: obtain the similarity between the extracted feature data and the face feature data in the whitelist; compare whether face feature data having similarity of greater than a preset threshold to the extracted feature data exists in the whitelist; and if the face feature data having similarity of greater than the preset threshold to the extracted feature data exists in the whitelist, determine that the face feature data consistent with the extracted feature data exists in the whitelist.

Similarly, when identifying whether the face feature data consistent with the extracted feature data exists in the blacklist, the first face detection module 404 may be configured to: obtain the similarity between the extracted feature data and the face feature data in the blacklist; compare whether face feature data having similarity of greater than a preset threshold to the extracted feature data exists in the blacklist; and if the face feature data having similarity of greater than the preset threshold to the extracted feature data exists in the blacklist, determine that the face feature data consistent with the extracted feature data exists in the blacklist.

Further, in still another embodiment of the access control apparatus according to the present disclosure, the control module 406 may further be configured to output a door closing control signal when the extracted feature data does not pass the authentication and an electronic door in the access control linkage apparatus is currently in an open state. The door closing control signal is used for performing a door closing operation by the access control linkage apparatus.

In addition, referring to FIG. 5 again, in still another embodiment of the access control apparatus according to the present disclosure, the apparatus may further include: an information database 410, configured to store a monitoring log. Accordingly, in this embodiment, the control module 406 is further configured to record user passage information in the monitoring log. The user passage information includes information of each user and the time when the user passes through the access control linkage apparatus or fails to pass the authentication. The user information may include user identification information, and/or the face feature data of the user.

Further According to one or more embodiments of the present disclosure, the control module 406 may further configured to receive a query request which includes a query condition, and query the user passage information satisfying the query condition from the monitoring log and output said information.

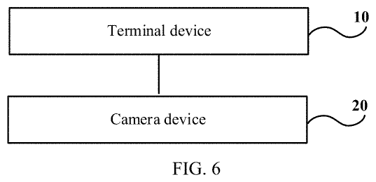

FIG. 6 is a schematic structural diagram of an embodiment of an access control system according to the present disclosure. The access control system of this embodiment may be configured to implement the foregoing embodiments of the access control method of the present disclosure. As show in FIG. 6, the access control system of this embodiment includes:

a terminal device 10, configured to: collect an image; perform face detection on the collected image; and in response to a face being detected in the collected image, perform feature data extraction on the face in the image to obtain face feature data of a user permitted to pass, and send the face feature data to a camera device 20.

The terminal device of the foregoing embodiments of the present disclosure may be, for example, a mobile terminal, a personal computer (PC), a tablet computer, a server, or the like.

The camera device 20 is configured to: receive the face feature data of the user permitted to pass sent by the terminal device 10, and store the face feature data of the user permitted to pass in a feature database built in the camera device 20; perform video data collection to obtain video data; perform face image detection on the video data; in response to a face image being detected, perform feature data extraction on the face image, and perform authentication on the extracted feature data based on the feature database; and output, according to a result of the authentication, a corresponding access control signal, the access control signal being used for opening or closing a door by an access control linkage apparatus.

Based on the access control system provided according to the foregoing embodiments of the present disclosure, video data collection is performed by means of a camera device, and face image detection is performed on the collected video data; when a face image is detected, feature data extraction is performed on the face image, authentication is performed on the extracted feature data based on a built-in feature database, and a door is controlled to be opened or closed according to a result of the authentication. Based on the embodiments of the present disclosure, a user does not need to enter a password or swipe a card when passing through an access control, thereby improving the convenience and safety; moreover, access control procedures, such as the video data collection, the face image detection, and the feature data extraction authentication, are performed based on the camera device itself, and do not need to be processed by a background server or a third-party server, so the detection time is short, the detection efficiency is high, and the amount of data transmitted by a network caused by data transmission with the background server or the third-party server is avoided, thereby improving the security of user data. Furthermore, data leakage and privacy problems caused to users by using the back-end server or the third-party server can be effectively reduced.

In one optional example of the access control system of the present disclosure, the camera device 20 may be implemented through the access control apparatus according to any one of the foregoing embodiments of the present disclosure. The control module 406 in the camera device 20 is configured to receive first user information sent by a service processing module 506 in the terminal device 10, and store the first user information in the feature database 408 built in the camera device 20. The first user information includes face feature data of a user permitted to pass, and furthermore, may also selectively include user identification information of the user permitted to pass, such as the name, age, gender, head photo, specific address and other related user information of the user.

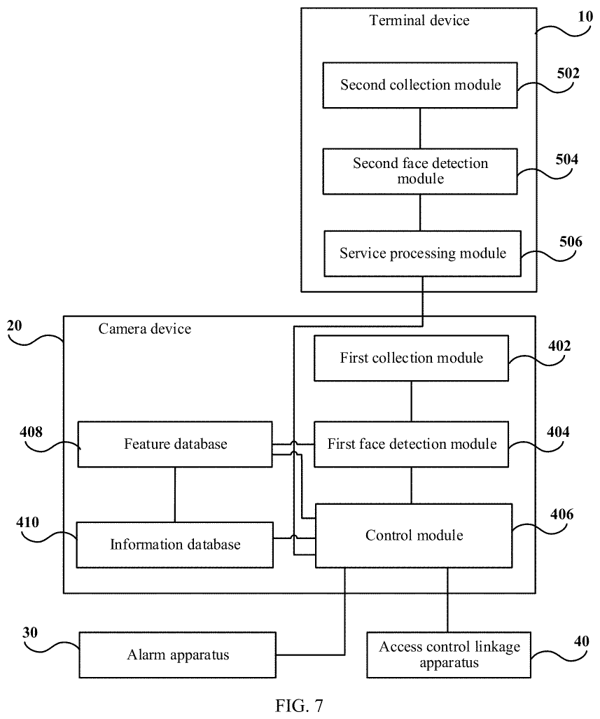

FIG. 7 is a schematic structural diagram of another embodiment of an access control system according to the present disclosure. As shown in FIG. 7, the terminal device 10 includes: a second collection module 502, a second face detection module 504, and a service processing module 506.

The second collection module 502 is configured to collect an image.

The second face detection module 504 is configured to: perform face detection on the image collected by the second collection module 502; and in response to a face being detected in the face, perform feature data extraction on the face in the image to obtain face feature data of a user permitted to pass.

The service processing module 506 is configured to send the first user information to the control module 406.

In addition, According to one or more embodiments of the present disclosure, the service processing module 506 may further be configured to send second user information of a user forbidden to pass to the camera device. The second user information includes face feature data of the user forbidden to pass, and furthermore, may also selectively include user identification information of the user forbidden to pass. Accordingly, the control module 406 may further be configured to store the second user information of the user forbidden to pass in the blacklist of the feature database 408.

Exemplarily, the service processing module 506 may establish a communication network (e.g., a mobile communication network, a mobile data network, a local area network, etc.) with the control module 406 in the camera device 20, and then perform information interaction through the communication network.

In addition, in another embodiment of the access control system according to the present disclosure, the service processing module 506 is further configured to: receive a query request and forward same to the control module 406, the query request including a query condition; and receive a query result returned by the control module 406 and output the query result. The query result may include user passage information satisfying the query condition.

Further, referring to FIG. 7 again, in yet another embodiment of the access control system of the present disclosure, the system may further include: an alarm apparatus 30, configured to give an alarm. For example, the alarm may be given by means of text, sound, light, electricity, and the like. Accordingly, in this embodiment, the control module 406 may further be configured to control the alarm apparatus 30 to give an alarm when the face feature data consistent with the extracted feature data exists in the blacklist.

Further, referring to FIG. 7 again, in yet another embodiment of the access control system of the present disclosure, the system may further include: an access control linkage apparatus 40, configured to receive an access control signal output by the camera device 20, and open or close a door according to the access control signal. When the camera device sends a door opening control signal, the access control linkage apparatus opens the door, on the contrary, when the camera device sends a door closing control signal, the access control linkage apparatus closes the door.

Exemplarily, the access control linkage apparatus 40 may include a relay and an electronic door, where the relay receives the access control signal output by the camera device 20 to control the electronic door to be opened or closed, thereby achieving an access control function.

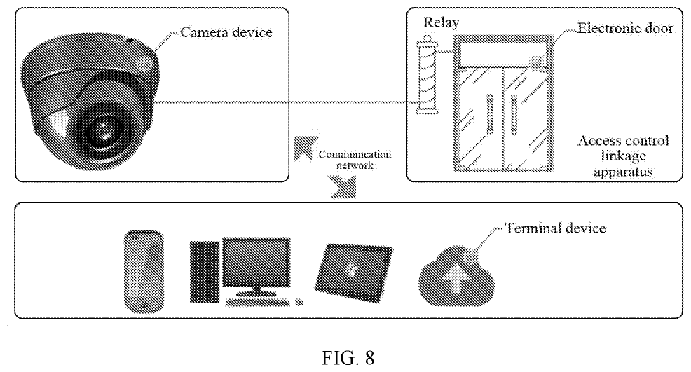

FIG. 8 is a schematic diagram of an embodiment of an access control system according to the present disclosure.

The embodiments of the present disclosure further provide an electronic device, including the access control linkage apparatus or the access control system according to any one of the foregoing embodiments of the present disclosure.

In addition, the embodiments of the present disclosure further provide another electronic device, including:

a processor and the access control apparatus according to any one of the foregoing embodiments of the present disclosure;

where when the processor runs the access control apparatus, modules in the access control apparatus according to any one of the foregoing embodiments of the present disclosure are run.

In addition, the embodiments of the present disclosure further provide still another electronic device, including:

a processor and the access control system according to any one of the foregoing embodiments of the present disclosure;

when the processor runs the access control system, modules in the access control system according to any one of the foregoing embodiments of the present disclosure are run.

In addition, the embodiments of the present disclosure further provide yet another electronic device, including:

a memory, which stores executable instructions; and

one or more processors, which communicate with the memory to execute the executable instructions so as to complete operations of the operations in the access control method according to any one of the foregoing embodiments of the present disclosure.

In addition, the embodiments of the present disclosure further provide a computer program, including a computer-readable code, where when the computer-readable code is run on a device, a processor in the device executes instructions for implementing the operations of the access control method according to any one of the foregoing embodiments of the present disclosure.

In addition, the embodiments of the present disclosure further provide a computer-readable medium, configured to store computer-readable instructions, where when the instructions are executed, operations of the operations in the access control method according to any one of the foregoing embodiments of the present disclosure are implemented.

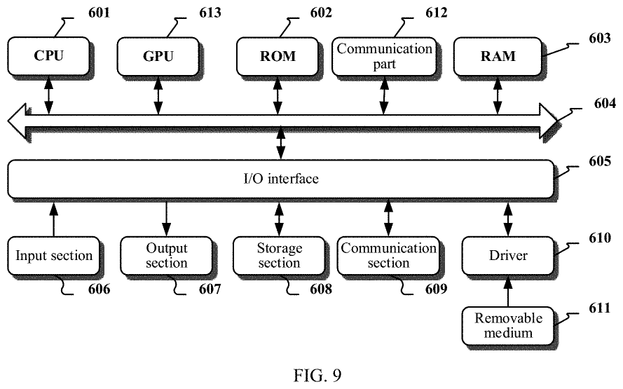

FIG. 9 is a schematic structural diagram of an embodiment of an electronic device according to the present disclosure. Referring to FIG. 9 below, a schematic structural diagram of an electronic device suitable for implementing a terminal device or a server according to the embodiments of the present disclosure is shown. As shown in FIG. 9, the electronic device includes one or more processors, a communication part, and the like. The one or more processors are, for example, one or more CPUs 601, and/or one or more Graphic Processing Units (GPUs) 613, and the like. The processor may execute various appropriate actions and processing according to executable instructions stored in a Read-Only Memory (ROM) 602 or executable instructions loaded from a storage section 608 to a RAM 603. The communication part 612 may include, but is not limited to, a network card. The network card may include, but is not limited to, an Infiniband (IB) network card. The processor may communicate with the ROM 602 and/or the RAM 603, to execute executable instructions. The processor is connected to the communication part 612 via a bus 604, and communicates with other target devices via the communication part 612, thereby implementing corresponding operations of any access control method provided in the embodiments of the present disclosure, for example, performing, by a camera device, video data collection to obtain video data; performing, by the camera device, face image detection on the video data; in response to a face image being detected, performing, by the camera device, feature data extraction on the face image, and performing authentication on the extracted feature data based on a feature database built in the camera device; outputting, by the camera device according to a result of the authentication, a corresponding access control signal which is used for opening or closing a door by an access control linkage apparatus.

In addition, the RAM 603 may further store various programs and data required for operations of an apparatus. The CPU 601, the ROM 602, and the RAM 603 are connected to each other by means of the bus 604. In the presence of the RAM 603, the ROM 602 is an optional module. The RAM 603 stores executable instructions, or writes executable instructions to the ROM 602 during running, where the executable instructions instruct the CPU 601 to perform corresponding operations of the foregoing access control method. An Input/Output (I/O) interface 605 is also connected to the bus 604. The communication part 612 is integrated, or is configured to have multiple sub-modules (for example, multiple IB network cards) connected to the bus.

The following components are connected to the I/O interface 605: an input section 606 including a keyboard, a mouse and the like; an output section 607 including a Cathode-Ray Tube (CRT), a Liquid Crystal Display (LCD), a speaker and the like; the storage section 608 including a hard disk drive and the like; and a communication section 609 of a network interface card including an LAN card, a modem and the like. The communication section 609 performs communication processing via a network such as the Internet. A drive 611 is also connected to the I/O interface 605 according to requirements. A removable medium 611 such as a magnetic disk, an optical disk, a magneto-optical disk, a semiconductor memory or the like is mounted on the drive 611 according to requirements, so that a computer program read from the removable medium is installed on the storage section 608 according to requirements.

It should be noted that the architecture shown in FIG. 9 is merely an optional implementation. During specific practice, the number and types of the components in FIG. 9 is selected, decreased, increased, or replaced according to actual requirements. Different functional components are separated or integrated or the like. For example, the GPU and the CPU are separated, or the GPU is integrated on the CPU, and the communication part is separated from or integrated on the CPU or the GPU or the like. These alternative implementations all fall within the scope of protection of the present disclosure.

Particularly, a process described above with reference to a flowchart according to the embodiments of the present disclosure is implemented as a computer software program. For example, the embodiments of the present disclosure include a computer program product, which includes a computer program tangibly contained on a machine-readable medium. The computer program includes a program code configured to execute the method shown in the flowchart. The program code may include corresponding instructions for correspondingly executing the operations of the access control method provided by the embodiments of the present disclosure, for example, an instruction for performing, by a camera device, video data collection to obtain video data; an instruction for performing, by the camera device, face image detection on the video data; an instruction for performing, by the camera device in response to a face image being detected, feature data extraction on the face image, and performing authentication on the extracted feature data based on a feature database built in the camera device; and an instruction for outputting, according to a result of the authentication, a corresponding access control signal which is used for opening or closing a door by an access control linkage apparatus.

Based on the electronic devices, programs, and media provided according to the foregoing embodiments of the present disclosure, a user does not need to enter a password or swipe a card when passing through an access control, thereby improving the convenience and safety; moreover, access control procedures, such as video data collection, face image detection, and feature data extraction and authentication, are performed based on the camera device itself, and do not need to be processed by a background server or a third-party server, so the detection time is short, the detection efficiency is high, and no data transmission with the background server or the third-party server is needed, thereby reducing the amount of data transmitted by a network and improving the security of user data. Furthermore, data leakage and privacy problems caused to users by using the back-end server or the third-party server can be effectively reduced.

The embodiments of the present disclosure can be used, for example, in the following scenarios:

intelligent access management for each resident in a community;

intelligent access management and attendance clock-in management for small, medium and large companies; and

security-focused intelligent access management for companies, enterprises or research institutions, or the like.

The embodiments of the present disclosure have at least the following total beneficial technical effects:

by performing face detection and recognition based on a camera device, there is no need to transmit the video data to a background server or a third-party server for face detection and recognition, thereby reducing network bandwidth problems caused by the video data output;

by performing face detection and recognition based on the camera device, there is no need to transmit the video data to the background server or the third-party server for face detection and recognition, thereby reducing the costs for deploying apparatuses required by the background server or the third-party server for face detection and recognition and data security problems;

by performing face detection and recognition based on the camera device, there is no need to transmit the video data to the background server or the third-party server for face detection and recognition, thereby improving the reliability of access control, avoiding the influence of the network, achieving high face recognition speed, and enabling the access control to be directly controlled according to the face recognition result in real time;

the terminal device may transmit the first user information and/or the second user information in the form of text data or binary data, thereby reducing the amount of data transmission, saving network bandwidth, and improving data transmission efficiency and success rate, so that the camera device can be conveniently managed by means of the terminal device;

by performing face detection and recognition based on a deep learning network, the recognition rate is high, for example, the recognition rate may be as high as 90% or more; and

except for the camera device, the terminal device configured to manage the camera device, and the access control linkage apparatus, no other external hardware devices, such as optical and thermal sensors, are needed, thereby avoiding hardware costs resulting from this.

The embodiments in the specification are all described in a progressive manner, for same or similar parts in the embodiments, refer to these embodiments, and each embodiment focuses on a difference from other embodiments. The system embodiments correspond to the method embodiments substantially and therefore are only described briefly, and for the associated part, refer to the descriptions of the method embodiments.

The methods and apparatuses in the present disclosure may be implemented in many manners. For example, the methods and apparatuses in the present disclosure may be implemented with software, hardware, firmware, or any combination of software, hardware, and firmware. Unless otherwise specially stated, the foregoing sequences of operations of the methods are merely for description, and are not intended to limit the operations of the methods of the present disclosure. In addition, in some embodiments, the present disclosure may also be implemented as programs recorded in a recording medium. The programs include machine-readable instructions for implementing the methods according to the present disclosure. Therefore, the present disclosure further covers the recording medium storing the programs for performing the methods according to the present disclosure.

The descriptions of the present disclosure are provided for the purpose of examples and description, and are not intended to be exhaustive or limit the present disclosure to the disclosed form. Many modifications and changes are obvious to persons of ordinary skill in the art. The embodiments are selected and described to better describe a principle and an actual disclosure of the present disclosure, and to make persons of ordinary skill in the art understand the present disclosure, so as to design various embodiments with various modifications applicable to particular use.

1. An access control method, comprising:
performing, by a camera device, video data collection to obtain video data;
performing, by the camera device, face image detection on the video data;
in response to a face image being detected, performing, by the camera device, authentication on the face image; and
outputting, by the camera device according to a result of the authentication, a corresponding access control signal, the access control signal being used for opening or closing a door by an access control linkage apparatus.

2. The method according to claim 1, wherein the performing, by the camera device, face image detection on the video data comprises: selecting, by the camera device, an image from the video data, and performing face detection on the selected image based on a deep learning network;
a face image being detected comprises: a face being detected in the selected image; and
the performing, by the camera device, authentication on the face image comprises: performing, by the camera device, feature data extraction on the face image based on the deep learning network, and performing authentication on the extracted feature data based on a feature database built in the camera device.

3. The method according to claim 2, wherein the outputting, by the camera device according to a result of the authentication, a corresponding access control signal comprises:
if the extracted feature data passes the authentication, outputting, by the camera device, a door opening control signal, the door opening control signal being used for performing a door opening operation by the access control linkage apparatus.

4. The method according to claim 3, wherein after the outputting, by the camera device, a door opening control signal, the method further comprises:
in response to no face image being detected within a preset time period, outputting, by the camera device, a door closing control signal, the door closing control signal being used for performing a door closing operation by the access control linkage apparatus.

5. The method according to claim 2, wherein the feature database comprises a whitelist, the whitelist is used for storing first user information, and the first user information comprises: face feature data of a user permitted to pass;
the performing authentication on the extracted feature data based on a feature database built in the camera device comprises:
identifying whether face feature data consistent with the extracted feature data exists in the whitelist; and
if the face feature data consistent with the extracted feature data exists in the whitelist, the extracted feature data passes the authentication; if no face feature data consistent with the extracted feature data exists in the whitelist, the extracted feature data does not pass the authentication.

6. The method according to claim 5, further comprising:
if no face feature data consistent with the extracted feature data exists in the whitelist, outputting, by the camera device, prompt information indicating that the current user is a stranger.

7. The method according to claim 2, wherein the feature database comprises a blacklist, the blacklist is used for storing second user information, and the second user information comprises: face feature data of a user forbidden to pass;
the performing authentication on the extracted feature data based on a feature database built in the camera device comprises:
identifying whether face feature data consistent with the extracted feature data exists in the blacklist; and
if the face feature data consistent with the extracted feature data exists in the blacklist, the extracted feature data does not pass the authentication.

8. The method according to claim 5, wherein a fact that the face feature data consistent with the extracted feature data exists comprises:
a fact that face feature data having similarity of greater than a preset threshold to the extracted feature data exists.

9. The method according to claim 1, wherein the outputting, by the camera device according to whether the extracted feature data passes the authentication, a corresponding access control signal comprises:
if the extracted feature data does not pass the authentication and an electronic door in the access control linkage apparatus is currently in an open state, outputting, by the camera device, a door closing control signal, the door closing control signal being used for performing a door closing operation by the access control linkage apparatus.

10. The method according to claim 6, further comprising:
if the face feature data consistent with the extracted feature data exists in the blacklist, controlling, by the camera device, an alarm apparatus to give an alarm.

11. The method according to claim 2, further comprising:
collecting an image;
performing face detection on the collected image;
in response to a face being detected in the collected image, extracting feature data of the face in the collected image to obtain the face feature data of the user permitted to pass; and
establishing, based on the face feature data of the user permitted to pass, corresponding first user information in the feature database, the first user information comprising: the face feature data of the user permitted to pass.

12. The method according to claim 11, wherein the establishing, based on the face feature data of the user permitted to pass, corresponding first user information in the feature database comprises:
sending the face feature data of the user permitted to pass and corresponding user identification information to the camera device by means of a terminal device; and
establishing, by the camera device, the first user information of the user permitted to pass in the whitelist of the feature database, the first user information further comprising the user identification information corresponding to the face feature data.

13. The method according to claim 2, further comprising:
sending the second user information of the user forbidden to pass to the camera device by means of the terminal device, the second user information comprising: the face feature data of the user forbidden to pass; and
storing, by the camera device, the second user information of the user forbidden to pass in the blacklist of the feature database.

14. The method according to claim 13, wherein the second user information further comprises user identification information of the user forbidden to pass.

15. The method according to claim 1, further comprising:
recording, by the camera device, user passage information in a monitoring log, the user passage information comprising information of each user and a time when the user passes through the access control linkage apparatus or fails to pass the authentication.

16. The method according to claim 15, further comprising:
in response to reception of a query request, querying the user passage information satisfying a query condition in the query request from the monitoring log and outputting said information.

17. An access control apparatus, comprising:
a memory storing processor-executable instructions; and
a processor arranged to execute the stored processor-executable instructions to perform steps of:
performing video data collection to obtain video data;
performing face image detection on the video data, and in response to a face image being detected, performing authentication on the face image; and
outputting, according to a result of the authentication output by the first face detection module, a corresponding access control signal, the access control signal being used for opening or closing a door by an access control linkage apparatus.

18. The apparatus according to claim 17, wherein the performing face image detection on the video data comprises: selecting an image from the video data to send to the first face detection module; and
performing face detection on the selected image based on a deep learning network; and in response to a face being detected in the selected image, performing feature data extraction on the face image based on the deep learning network, and performing authentication on the extracted feature data based on a feature database.

19. An access control system, comprising:
a terminal device comprising a memory storing processor-executable instructions; and a processor configured to execute the stored processor-executable instructions to perform steps of: collecting an image; performing face detection on the collected image; and in response to a face being detected in the collected image, performing feature data extraction on the face in the image to obtain face feature data of a user permitted to pass, and sending the face feature data to a camera device; and
a camera device, configured to: receive the face feature data of the user permitted to pass sent by the terminal device, and store the face feature data of the user permitted to pass in a feature database built in the camera device; perform video data collection to obtain video data; perform face image detection on the video data; in response to a face image being detected, perform feature data extraction on the face image, and perform authentication on the extracted feature data based on the feature database; and output, according to a result of the authentication, a corresponding access control signal, the access control signal being used for opening or closing a door by an access control linkage apparatus.

20. A non-transitory computer-readable medium having stored thereon computer-readable instructions that, when executed by a processor, cause the processor to implement operations of the access control method according to claim 1.
